(19) United States
(12) Patent Application Publication
(10) Pub. No.: US 2009/0192833 A1
(43) Pub. Date: Jul. 30, 2009

(54) TICKET REFUNDING SYSTEM AND METHOD

(76) Inventor: RANDY MERSKY, Silver Spring, MD (US)

Correspondence Address: GREENBLUM & BERNSTEIN, P.L.C., 1950 ROLAND CLARKE PLACE, RESTON, VA, 20191, US

(21) Appl. No.: 12/021,025

(22) Filed: Jan. 28, 2008

(51) Int. Cl. G06Q 20/00; G06Q 10/00

(52) U.S. Cl. 705/5; 705/39; 705/45

(57) ABSTRACT

A system and method refund a current value of an event ticket to a user. The ticket is purchased from a ticket issuer and out of a pool of tickets. Information associated with the event ticket is obtained from a physical event ticket provided by a user to a kiosk. Ticket information is provided to at least one of: the ticket issuer, an event coordinator, venue owner, a third party or to the Internet via a query. In response, these sources return information associated with the event for which the event ticket was purchased. Subsequently, the kiosk calculates a current value for the event ticket based on at least one of the ticket information and event information. The current value is refunded to the user of the kiosk and the ticket issuer returns the ticket to the pool of available tickets.

### BACKGROUND OF THE INVENTION

1. Field of the Invention

The present invention relates to refunding the current value of an event ticket to a user, and more particularly, enabling a ticket issuer to return the event ticket to a pool of available tickets.

2. Background Information

A ticket holder wishing to dispose of a ticket may currently resell their ticket by scalping their ticket or reselling the ticket through a professional ticket broker. A ticket scalper will attempt to resell the ticket by offering the ticket for sale in close physical proximity to the location of the ticketed event, during or near to the commencement of the event. Thus, a disadvantage to reselling a ticket through a ticket scalper lies in the fact that the ticket cannot be resold with any certainty, not to mention its questionable legality and personal risk. Furthermore, a ticket resold by a ticket scalper will typically sell at much less than the face value of the ticket because it is sold directly preceding or during the ticketed event. Moreover, ticket scalping would require the physical presence of both the ticket holder and the ticket purchaser at the ticketed event.

An online ticket broker or online auction site enables ticket holders to exchange tickets with ticket buyers for monetary consideration at agreed upon prices. However, online ticket brokers typically require a shipping address where the tickets are mailed from a seller to a buyer. This means that, while money may exchange between parties upon completion of the online transaction, the buyer may not receive the actual ticket and the seller may not receive payment until much after the transaction has concluded and the event has passed, if at all. There is also a chance that the resold tickets mailed to the buyer are fraudulent, cancelled or invalid. Furthermore, online ticket brokers cannot offer the opportunity to make last minute purchases. Insofar as most online ticket brokers require the mailing of a ticket and payment for the ticket, online ticket brokers do not make last minute ticket disposal or ticket purchasing opportunities available.

A professional ticket broker will use a network of contacts to obtain and sell tickets to events that are in demand. One disadvantage lies in the fact that in most cases, both professional and online ticket brokers will charge a commission for reselling the ticket or enabling the transaction. This commission is typically obtained from both the seller and the buyer.

However, none of these methods allow a ticket issuer to immediately obtain the unused ticket, make the ticket available to be resold and resell the ticket at the ticket issuer's own terms at a chosen market value. Furthermore, current technologies do not provide adequate fraud protection from a ticket holder who attempts to resell a ticket more than once. More particularly, these methods do nothing to invalidate a resold ticket, either virtually (e.g., by invalidating a ticket identifier) or physically (e.g., by destroying or capturing the ticket). In addition, currently available technologies are not convenient to a ticket holder wishing to obtain a refund for a ticket prior to the ticketed event.

### SUMMARY OF THE INVENTION

Advantageously, the present invention provides a ticket holder with the ability to obtain a refund for an event ticket at a ticket accepting/recycling location. The method does not introduce significant cost to a ticket issuer, a venue owner or event coordinator implementing a portion of or all the components of the system or steps of the method. Furthermore, the present invention provides each of these parties with the added incentive of an additional source of revenue generating operations. In addition, the present invention provides ticket purchasers with a last minute opportunity to obtain tickets for sold-out events. Moreover, the present invention provides ticket resale prices to a ticket purchaser that are more fair than ticket resale prices that would be characteristic of an interaction with a ticket scalper.

Additionally, one advantage of the present invention is that a consumer is provided with an opportunity to purchase refundable tickets. Advantageously, consumer loyalty with respect to any of the ticket issuer, event coordinator and venue owner may be enhanced.

Advantageously, a secure system and method for obtaining tickets, invalidating tickets and refunding a current value for the ticket is provided. Additionally, the system and method of the present invention provide peace of mind heretofore unavailable to a ticket holder wishing to obtain a refund for the current value of the event ticket.

In addition, the present invention provides multifunctional kiosks handling ticket refunding as well as other services (e.g., automated teller, coin-counting and vending services). Multifunctional kiosks may be located in popular areas such as malls, stores and universities. In one embodiment, automated teller machines (ATMs) may be retrofitted to provide the ticket refunding service of the present invention.

According to one aspect of the present invention, there is provided a method of refunding a current value of an event ticket to a user that the user previously purchased from a ticket issuer out of a pool of available tickets. The method includes obtaining information associated with the event ticket and determining the current value of the event ticket based the information associated with the event ticket and information associated with an event, the event being associated with the event ticket. The method further includes refunding the determined current value of the event ticket to the user.

According to another aspect of the present invention, the method further includes displaying the information associated with the event ticket to the user.

According to yet another aspect of the present invention, the method further includes the user verifying the information associated with the event ticket.

According to still another aspect of the present invention, the method further includes electronically transmitting one of an image of the event ticket and the information associated with the event ticket to at least one of a third party and the ticket issuer.

According to a further aspect of the present invention, at least one of the third party and the ticket issuer validates the information associated with the ticket.

According to another aspect of the present invention, the information associated with the event is obtained from at least one of a third party and the ticket issuer.

According to yet another aspect of the present invention, the information associated with the event is electronically transmitted to a computer.

According to a further aspect of the present invention, the computer is a kiosk connected to a network.

According to still another aspect of the present invention, the network is connected either or both the ticket issuer or a third party.

According to yet another aspect of the present invention, one or more of the computer, the ticket issuer and a third party determine the current value of the event ticket.

According to a further aspect of the present invention, the current value of the event ticket is refunded to the user by a credit to a credit card, a check mailed to the user, cash returned to the user, a credit to a debit card, a credit to an account or an automated clearinghouse transaction to the account.

According to another aspect of the present invention, the information associated with the event ticket includes an event name, a face value of the ticket, a venue associated with the event, a seat assignment at the venue, a time of the event and a date of the event.

According to yet another aspect of the present invention, the information obtained from the ticket issuer includes an amount of time remaining before commencement of an event, ticket demand for the event, publicity associated with the event, a date of purchase of the ticket, a purchase price for the ticket and an original price of the ticket.

According to one aspect of the present invention, the method also includes returning the event ticket to the pool of available tickets.

According to a still further aspect of the present invention, either or both the ticket issuer and a third party returns the event ticket to the pool of available tickets.

According to another aspect of the present invention, returning the event ticket to the pool of available tickets includes making the event ticket available to be resold by the ticket issuer.

According to yet another aspect of the present invention, determining the current value is further based on ticket holder information.

According to a further aspect of the present invention, ticket holder information includes name, credit card information, cellular telephone number, landline telephone number, personal identification number (PIN), email address, account information, social security number (SSN) and biometric information associated with the user.

According to one aspect of the present invention, there is provided a system for refunding a current value of ticket to a user. The ticket is purchased previously from a ticket issuer out of a pool of available tickets. The system includes an interface that scans the ticket provided by the user and a ticket processor that obtains information associated with the ticket. The system further includes a current value processor that calculates the current value of the ticket, based on information associated with the ticket, ticket holder information and information associated with an event, the event being associated with the ticket. The system also includes a refund processor that refunds the calculated current value of the ticket to the user.

According to one aspect of the present invention, the system also includes a return processor that electronically returns the ticket to the pool of available tickets.

According to another aspect of the present invention, the system also includes a transmitter configurable to transmit the information associated with the ticket.

According to yet another aspect of the present invention, the system also includes a receiver that receives the information associated with the event, the event being associated with the ticket.

According to a further aspect of the present invention, the interface is a ticket scanner.

According to a still further aspect of the present invention, the transmitter, the receiver and the interface are implemented in a kiosk.

According to one aspect of the present invention, the current value processor is implemented by one of the ticket issuer, a third party and an owner of the interface.

According to another aspect of the present invention, the refund processor is implemented by one of the ticket issuer, a third party and an owner of the interface.

According to yet another aspect of the present invention, the return processor is implemented by one of the ticket issuer, a third party and an owner of the interface.

According to one aspect of the present invention, at least one of the current value processor, the refund processor and the return processor are implemented by an owner of the kiosk.

According to a further aspect of the present invention, the system also includes an invalidating processor that invalidates the ticket.

According to still further aspect of the present invention, invalidating the ticket comprises capturing the ticket, destroying the ticket, marking the ticket in a manner visible to the user, and marking the ticket in a manner not visible to the user.

According to one aspect of the present invention, marking the ticket in the manner not visible to the user includes deactivating a magnetic strip on the ticket.

According to a still further aspect of the present invention, the information associated with the event is obtained from the ticket issuer, a coordinator of the event, an owner of a venue associated with the event, a third party and the Internet.

According to another aspect of the present invention, the information associated with the event is obtained in real-time over a communications link.

According to yet another aspect of the present invention, the information associated with the event is received at periodic time intervals.

According to one aspect of the present invention, a tangible computer readable medium that stores a computer program that refunds a current value of a ticket to a user is provided. The ticket is purchased previously from a ticket issuer out of a pool of ticket. The medium includes a receiving code that obtains information associated with the ticket. The medium also includes a calculating code that determines the current value of the ticket based on at least one of the information associated with the ticket and information associated with an event, the event being associated with the ticket. The medium further includes a refund code that refunds the determined current value of the ticket to the user.

According to another aspect of the present invention, the medium further includes a return code that returns the ticket to the pool of available tickets.

According to one aspect of the present invention, there is provided a method of refunding a current value of an event ticket to a user that the user previously purchased from a ticket issuer out of a pool of available tickets. The method includes obtaining information associated with the event ticket and determining the current value of the event ticket based the information associated with the event ticket, ticket holder information and information associated with an event, the event being associated with the event ticket. The method further includes refunding the determined current value of the event ticket to the user. The method also includes returning the event ticket to the pool of available tickets. The pool of available tickets are associated with the ticket issuer.

Other exemplary embodiments and advantages of the present invention may be ascertained by reviewing the present invention and the accompanying drawings, and the above description should not be considered to limit the scope of the present invention.

### BRIEF DESCRIPTION OF THE DRAWINGS

The present invention provides the detailed description that follows by reference to the noted drawings by way of non-limiting examples, in which like reference numerals represent similar parts throughout several views of the drawings, and in which:

FIG. 1 illustrates a network diagram of a ticket refunding process;

FIG. 2 illustrates a system diagram of a kiosk of the present invention;

FIG. 3 illustrates a system diagram of a ticket issuer of the present invention;

FIG. 4 is an exemplary process flow diagram for the ticket refunding process;

FIG. 5 is an exemplary process flow diagram for the kiosk; and

FIG. 6 is an exemplary process flow diagram for the ticket issuer.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

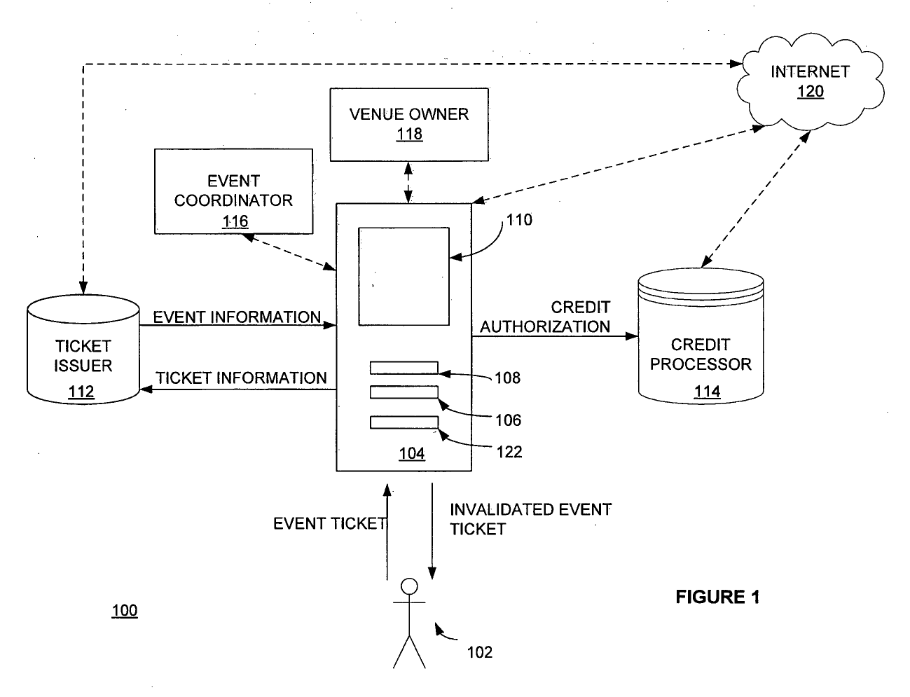

Referring now to FIG. 1, a network diagram of the ticket refunding process of the present invention is shown. A user 102 provides an event ticket to a scanner 106, which may be a slot of a kiosk 104. As used herein, the term “kiosk” may include any of, but not limited to: a standalone kiosk, a vending machine, an automated teller machine, a cash register, a checkout scanner, a personal computer (PC), a tablet PC, a laptop computer, a personal digital assistant (PDA), point-of-sale (POS) terminal, or any other suitable device. A kiosk may be stationary or may be mobile. Those skilled in the art will recognize numerous electronic devices to which the user may provide the event ticket. In one non-limiting embodiment, the kiosk 104 is not a physical device. For example, the kiosk 104 may be implemented as a website to which an electronic ticket or ticket identifier is provided.

An event ticket is evidence that a ticket holder has purchased a right to gain access to a ticketed event such as: a concert, performance, and sporting event and a service such as: as parking, transportation or commodities use. The event ticket is purchased from a ticket issuer 112 from a pool of available tickets. Those skilled in the art would readily appreciate that an event ticket need not necessarily be represented by a physical ticket, but rather may be represented by a ticket identifier stored in a cellular phone, wireless device, laptop computer, digital camera, PDA, paging device, voice recorder, flash memory, smart card or other electronic device. An electronically stored ticket identifier is electronically transmitted from the user's electronic device to the kiosk. In an alternative non-limiting embodiment, the user may manually enter the ticket identifier to the kiosk 104. A ticket identifier may be represented by an alphanumeric string or any other suitable method of data representation.

The kiosk 104 scans the event ticket and displays information associated with the event ticket or ticket identifier (i.e., ticket information) on a display screen 110. The term “scan” as used herein is meant to indicate that information is obtained from the event ticket or the ticket identifier. For example, ticket information may be obtained from a magnetic strip, barcode, radio frequency identifier (RFID), watermark, media object, or data object embedded/encoded in either the event ticket or the ticket identifier. Ticket information may also be obtained via optical character recognition (OCR). Ticket information includes: an event name, a face value of the event ticket, a venue associated with the event, as well as a time and date of the event, and the like. In one embodiment, the user 102 may manually enter or electronically transmit at least one of: information associated with a ticket holder (i.e., ticket holder information) or a ticket identifier. Ticket holder information includes, but is not limited to: the ticket holder's name, credit card information, cellular telephone number, landline telephone number, personal identification number (PIN), email address, mailing address, account information, social security number (SSN) and other unique, identifying information. In one embodiment, ticket holder information may include biometric data obtained from the user.

The ticket information is sent to the ticket issuer 112 or alternatively, to a third party processor separate from the ticket issuer, which returns information associated with the event (i.e., event information) to the kiosk 104. Those skilled in the art would readily appreciate that the third party processor may implement a portion of or all of the components of the system and/or a portion of or all of the steps of the method of the present invention. Event information includes: the amount of time remaining before commencement of an event, ticket demand for the event, a date of purchase of the event ticket, a purchase price for the event ticket and an original price of the event ticket. In one embodiment, ticket demand is determined from a waiting list of consumers waiting to purchase returned tickets. In another embodiment, the kiosk 104 sends ticket information to and obtains event information from at least one of: an event coordinator 116, a venue owner 118, or the Internet 120. In one embodiment, event coordinator 116 is an event management company or a performing arts company and venue owner 118 is a stadium owner, theater owner, or property management company. In one non-limiting embodiment, ticket issuer 112 and credit processor 114 are also connected via Internet 120.

Based on the ticket information and the event information, the kiosk 104 calculates an amount by which the user 102 is refunded. In an alternative, non-limiting embodiment, the ticket issuer 112 may calculate the amount by which the user 102 is refunded. In yet another non-limiting embodiment, the third party processor may calculate the amount by which the user 102 is refunded. For example, the amount by which the user 102 may be determined by using a portion of or all the event information and/or by using a portion of or all the ticket information for the ticket as inputs to a formula. In the case of ticket information or event information that is qualitative in nature (e.g., an event name), a numerical representation of the information may be applied as input to the formula. For example, a venue may be numerically represented by a scale of 1-10. A venue represented by a “1” may be a less desirable venue due to a lack of availability of parking, crime statistics in neighborhood, or distance from public transportation. An event may be numerically represented by a scale of 1-5, where an event represented by a “5” indicates that a relatively large amount of overhead is associated with the event. In one embodiment, a date of purchase might be important to determine whether a discount was applied to the purchase of the ticket. For example, a 10% discount for senior citizens might apply to tickets sold on Wednesdays. Calculations may be based on the original price of the ticket.

The formula may additionally take into account a portion of or all the ticket holder information. For example, certain ticket holders may be awarded a preferred status based on a ticket buying history, a credit card program membership or a type of credit card held by the ticket holder. These preferred ticket holders may be refunded more than another ticket holder holding a ticket to the same event. Thus, ticket holder information including, but not limited to: credit card number may be used to determine that the ticket holder should be awarded a preferred status (e.g., American Express Black or White credit card holders). Other ticket holder information such as the ticket holder's name, personal identification number (PIN), email address may be used to obtain other information including, but not limited to: history with the ticket issuer or a third party, program memberships, household financials and other stored information. In one non-limiting embodiment, ticket holder information may be numerically represented by a “1” indicating that the user is to be conferred the benefits of preferred status or by a “0” indicating that the user is to not to be conferred the benefits of preferred status.

Shown below are non-limiting examples of formulas used to calculate an amount by which the user 102 is refunded. It may be readily appreciated by those skilled in the art that a formula for calculating the amount by which the user is refunded may include quantitative, as well as non-numeric qualitative and descriptive inputs. Inputs may be binary, ordinal, rankings, and the like. In one embodiment, the formula may include case-based logic.

$$\begin{matrix}R = F - 10 \times {( {T}_{R} )}^{- 1} - V \times {T}_{D} & ( eq . 1 ) \\ R = P - E \times {( {T}_{R} )}^{- 1} & ( eq . 2 ) \\ R = O * ( 1 + {D}_{P} ) - {( {T}_{R} )}^{- 1} & ( eq . 3 ) \\ \begin{matrix}R = P - 100 \times {( {T}_{R} )}^{- 1} , & if {T}_{H} = 0 \\ F , & if {T}_{H} = 1\end{matrix} & ( eq . 4 )\end{matrix}$$

F=face value of the event ticket

E=numerical representation of event name

V=numerical representation of the venue

T_{R}=time remaining before the commencement of the event

T_{D}=ticket demand, units of ticket requests and tickets sold per available tickets

D_{P}=date of purchase

P=purchase price for the event ticket

O=original price of the event ticket

T_{H}=ticket holder information

R=refund amount

In one embodiment, the amount by which the user 102 is refunded is different from the purchase price. In an alternative embodiment, the amount by which the user 102 is refunded is equal to the purchase price. Pursuant to an agreement with the ticket issuer 112, the kiosk 104 sends a credit authorization to a credit processor 114. In another embodiment, the third party processor sends a credit authorization to a credit processor 114. In yet another embodiment, the ticket issuer 112 sends a credit authorization to the credit processor 114. For example, credit processor 114 is a financial institution, a credit card company or loan originator. Credit processor 114 credits an account, debit card, credit card or initiates the mailing of a check to the user 102. In one embodiment, the user 102 provides a credit card to the kiosk 104 using credit card slot 122. The credit processor 114 may credit the account based on the ticket holder information initially submitted to the kiosk 104 or based on the credit card provided to the credit card slot 122. In an alternative embodiment, the kiosk 104 refunds the user 102 with cash. Kiosk 104 destroys, or alternatively, invalidates and returns the event ticket to the user 102 via a return ticket slot 108. The amount that is refunded to the user 102 is displayed on the display screen 110. Ticket issuer 112 returns the seat assignment, space allotment or ticket identifier associated with the event ticket to the pool of available tickets. In an alternative embodiment, the third party processor returns the event ticket to the pool of available tickets. In another alternative embodiment, the event ticket is not returned to the pool of available tickets. For example, the user 102 may be a season ticket holder. The ticket issuer 102 may choose not to return the season ticket to the pool of available tickets because the ticket holder may wish to use the season ticket by attending future events.

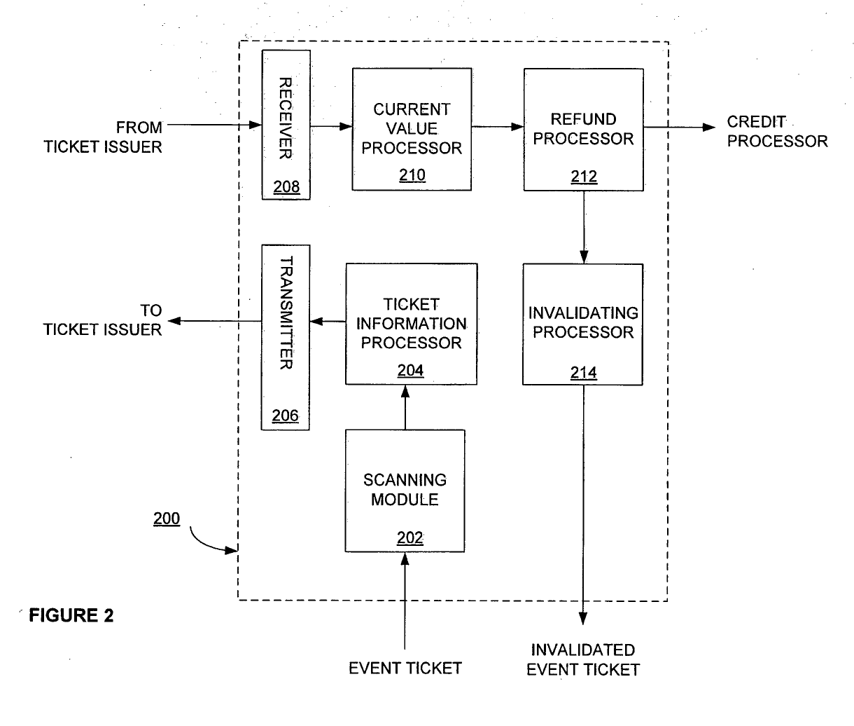

Shown in FIG. 2 is a system diagram of a kiosk 200 according to a non-limiting embodiment of the present invention. An event ticket is provided to a scanning module 202 which scans the event ticket a scanned image of the event ticket. The scanned image of the event ticket is provided to a ticket information processor 204 which obtains ticket information, displays the ticket information to the user and provides the ticket information to a transmitter 206. Transmitter 206 transmits the ticket information to a ticket issuer. In another embodiment, the scanned image of the event ticket is transmitted to the ticket issuer. In yet another embodiment, the ticket information is also transmitted to any of: an event coordinator, a venue owner or the Internet. A receiver 208 receives event information froth the ticket issuer. In another embodiment, the receiver 208 receives event information from the event coordinator, the venue owner or the Internet. Event information is provided to a current value processor 210 which determines a current value for the event ticket. The current value for the event ticket is calculated based on a number of factors. Factors may include, but are not limited to: an amount of time remaining before commencement of an event, ticket demand for the event, a date of purchase of the ticket, a purchase price for the ticket, publicity associated with the event, and an original price of the ticket. An amount of money corresponding to the current value of the event ticket is subsequently refunded to the user 102.

The current value processor 210 provides the calculated current value to a refund processor 212 which sends a credit authorization in the amount of the current value to the credit processor. Current value processor 210 also displays the current value of the event ticket that is refunded to the user and provides the calculated current value to an invalidating processor 214. Invalidating processor 214 destroys the event ticket or alternatively, invalidates the physical event ticket and returns the invalidated event ticket to the user. In one alternative embodiment, one or more of the current value processor 210, the refund processor 212 and the invalidating processor 214 are implemented at the ticket issuer 112. In another embodiment, one or more of the current value processor 210, the refund processor 212 and the invalidating processor 214 are implemented at the third party processor.

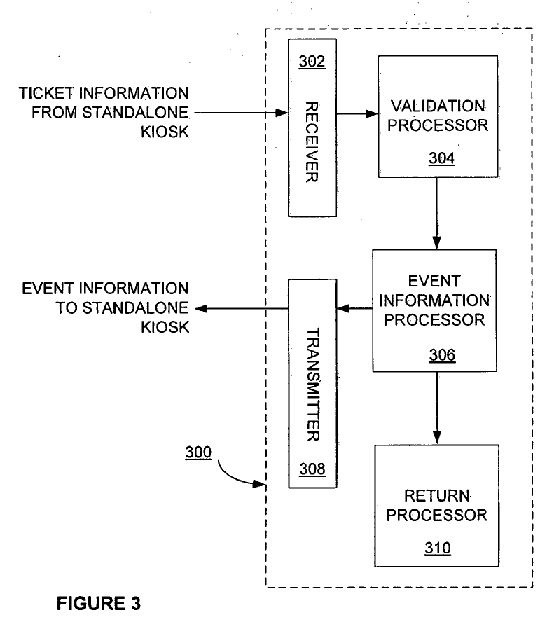

Referring to FIG. 3, a system diagram of the ticket issuer is shown. A receiver 302 receives at least one of: ticket information and a scanned image of the event ticket from the kiosk. Receiver 302 provides the ticket information to validation processor 304. Validation processor 304 determines whether the ticket information is valid. For example, the ticket information may be matched against a list of events for which the ticket issuer 300 issued event tickets. In one embodiment, the validation processor uses the scanned image of the event ticket to determine whether the ticket is counterfeit. For example, the validation processor 304 may compare the scanned image with a list of season ticket holders to ensure that the event ticket is authentic.

An event information processor 306 provides event information to a transmitter 308 and a return processor 310. Transmitter 308 transmits the event information to the kiosk. Return processor 310 returns the event ticket to the pool of available tickets. In certain situations (e.g., if it is too late for the ticket to be resold), the event ticket is not returned to the pool of available tickets. It is not necessary that the physical event ticket be returned to the pool of available tickets; rather the seat assignment, space allotment or ticket identifier associated with the event ticket is used for reclamation. In one non-limiting embodiment, the ticket refunding process operates in a consignment-type situation. For example, the venue owner, event coordinator, third party, or ticket issuer guarantees a refund value to the user upon the initial purchase of the ticket. In another embodiment, the refund value is based on the ability to resell the event ticket and is determined upon return of the event ticket by the user to the kiosk. In yet another embodiment, the user is not refunded the current value of the event ticket unless or until the event ticket is resold at a later date. In yet another embodiment, the refund value is a credit towards an event ticket for another event of the same or different type.

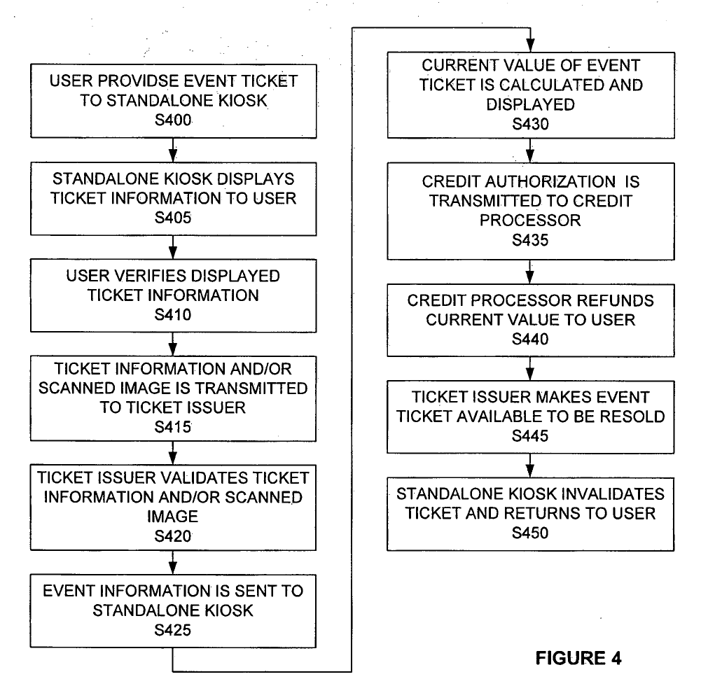

Shown in FIG. 4 is an exemplary process flow diagram for the ticket refunding process. In step S400, the user gives an event ticket to the kiosk. The kiosk displays ticket information to the user in step S405. In step S410, the user verifies that the displayed ticket information is correct. In one embodiment, a scanned image of the event ticket is displayed to the customer. Subsequently, in step S415, at least one of the ticket information and the scanned image of the event ticket is electronically transmitted to the ticket issuer. Next in step S420, the ticket issuer validates either or both the ticket information and the scanned image of the event ticket. In step S425, event information is sent to the kiosk from the ticket issuer. The process continues to step S430 where the current value of the event ticket is calculated. Proceeding to step S435, a credit authorization is transmitted to a credit processor to refund the current value of the event ticket to the user.

Next, in step S440, the credit processor refunds the current value of the event ticket to the user. This is accomplished by crediting an account, debit card, credit card or initiates the mailing of a check to the user. In an alternative embodiment, the kiosk refunds the user with cash. Subsequently, in step S445, the ticket issuer optionally makes the event ticket available to be resold by returning the event ticket back to the pool of available tickets. Finally, the process concludes in step S450 when the kiosk destroys, captures or alternatively, invalidates the physical event ticket and returns the invalidated event ticket to the user.

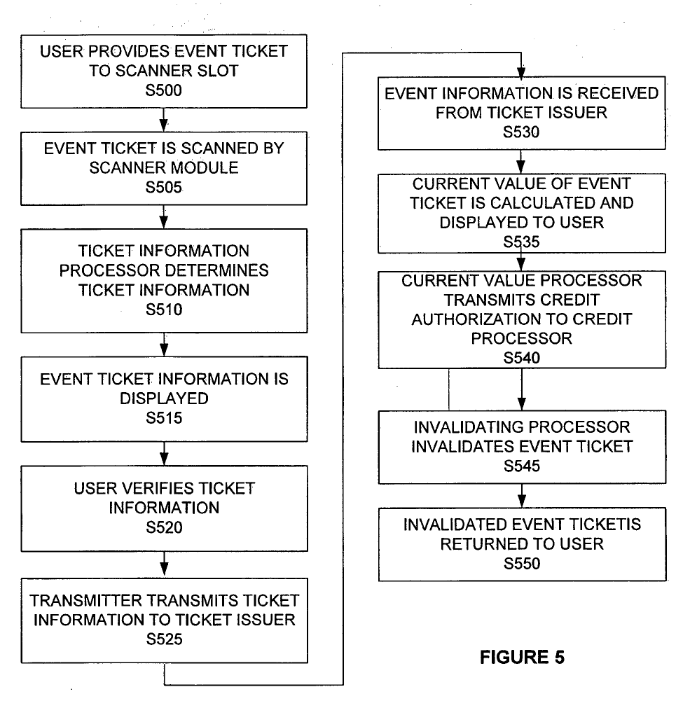

Shown in FIG. 5 is an exemplary process flow diagram for the kiosk. In step S500, the user provides an event ticket to the scanning slot of the kiosk. The event ticket is scanned by the scanner module in step S503. Continuing in step S510, a ticket information processor obtains ticket information. The ticket information processor displays the ticket information on the display screen in step S515. Next, in step S520, the user verifies the ticket information that is displayed on the display screen. Subsequently, in step S525, the transmitter transmits ticket information to the ticket issuer. In one embodiment, the kiosk transmits the ticket information to at least one of: a third party processor, an event coordinator, a venue owner and the Internet. The kiosk eventually receives event information from the ticket issuer in step S530. In another embodiment, the event information is received from at least one of the third party processor, event coordinator, the venue owner and the Internet. Event information is received on regular intervals, upon request or is streamed continuously from these sources.

Based on the received event information, a current value for the event ticket is calculated in step S535. In step S540, the current value processor in the kiosk transmits a credit authorization to the credit processor to refund the current value of the event ticket to the user. Additionally, in step S540, the current value processor displays the current value of the event ticket refunded to the user on the kiosk. Subsequently, in step S545 the invalidating processor invalidates or captures the physical event ticket. The invalidation processor may mark the event ticket in a manner visible to the user. For example, an invalidated event ticket may be punched, stamped or otherwise marked with an “X” or the word “invalid” or “void.” Alternatively, the invalidating processor destroys or marks the event ticket as invalid in a manner that is not visible to the user. For example, a magnetic strip on an event ticket is deactivated or marked with an invalidity beacon. Finally, in step S550, the invalidated event ticket is returned to the user.

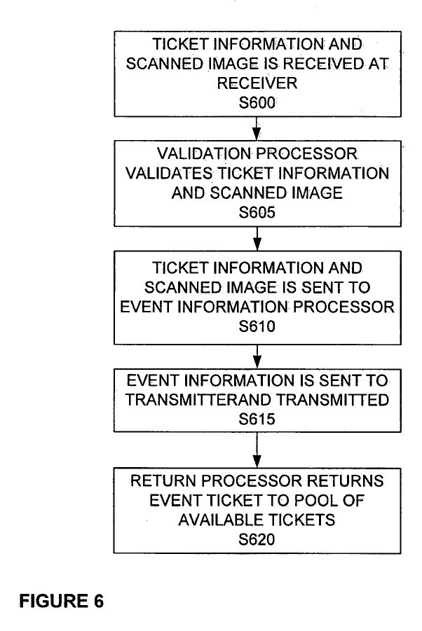

In FIG. 6, an exemplary process flow diagram for the ticket issuer or the third party processor is shown. The ticket issuer or the third party processor receives ticket information from the kiosk in step S600. In step S605, the validation processor validates the ticket information. In one embodiment, the ticket issuer or the third party processor receives the scanned image of the event ticket and the validation processor validates the scanned image. In step S610, the event information processor obtains at least one of: ticket information and the scanned image of the event ticket from the validation processor. In one embodiment, the event information processor is a relational database that uses ticket information to form database queries which return event information. Subsequently, in step S615, event information is sent to the transmitter located at the ticket issuer or the third party processor, the transmitter transmits the event information to the kiosk. In step S620, the return processor optionally makes the event ticket available by returning the event ticket to the pool of available tickets, based on a seat assignment, space allotment or other ticket identifier obtained from the kiosk. Tickets may subsequently be resold.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed. Rather, the invention extends to all functionally equivalent structures, methods and uses such as are within the scope of the appended claims.

What is claimed is:

1. A method of refunding a current value of an event ticket to a user, the event ticket having previously been purchased from a ticket issuer out of a pool of available tickets, the method comprising:
obtaining information associated with the event ticket;
determining the current value of the event ticket based on at least one of the information associated with the event ticket and information associated with an event, the event being associated with the event ticket; and
refunding the determined current value of the event ticket to the user.

2. The method according to claim 1, further comprising displaying the information associated with the event ticket to the user.

3. The method according to claim 2, wherein the user verifies the information associated with the event ticket.

4. The method according to claim 1, further comprising electronically transmitting one of an image of the event ticket and the information associated with the event ticket to at least one of a third party and the ticket issuer.

5. The method according to claim 4, wherein at least one of the third party and the ticket issuer validates the information associated with the ticket.

6. The method according to claim 1, wherein the information associated with the event is obtained from at least one of a third party and the ticket issuer.

7. The method according to claim 1, wherein the information associated with the event is electronically transmitted to a computer.

8. The method according to claim 7, wherein the computer comprises a kiosk connected to a network.

9. The method according to claim 8, wherein the network is connected to at least one of the ticket issuer and a third party.

10. The method according to claim 9, wherein at least of one of the computer, the ticket issuer and the third party determine the current value of the event ticket.

11. The method according to claim 9, wherein at least one of the computer, the ticket issuer and the third party refund the determined current value of the event ticket to the user.

12. The method according to claim 1, wherein the current value of the event ticket is refunded to the user by at least one of: a credit to a credit card, a check mailed to the user, cash returned to the user, a credit to a debit card, a credit to an account and an automated clearinghouse transaction to the account.

13. The method according to claim 1, wherein the information associated with the event ticket comprises at least one of: an event name, a face value of the ticket, a venue associated with the event, a seat assignment at the venue, a time of the event and a date of the event.

14. The method according to claim 1, wherein the information associated with the event comprises at least one of: an amount of time remaining before commencement of an event, ticket demand for the event, publicity associated with the event, a date of purchase of the ticket, a purchase price for the ticket and an original price of the ticket.

15. The method according to claim 1, further comprising returning the event ticket to the pool of available tickets.

16. The method according to claim 15, wherein at least one of the ticket issuer and a third party return the ticket to the pool of available tickets.

17. The method according to claim 15, wherein returning the event ticket to the pool of available tickets comprises making the event ticket available to be resold.

18. The method according to claim 1, wherein determining the current value is further based on ticket holder information.

19. The method according to claim 18, wherein ticket holder information comprises at least one of: name, credit card information, cellular telephone number, landline telephone number, personal identification number (PIN), email address, account information, social security number (SSN) and biometric information associated with the user.

20. A system for refunding a current value of a ticket to a user, the ticket having previously been purchased from a ticket issuer out of a pool of available tickets, the system comprising:
an interface configurable to scan the ticket provided by the user;
a ticket processor configurable to obtain information associated with the ticket;
a current value processor configurable to calculate the current value of the ticket, based on at least one of the information associated with the ticket, ticket holder information and information associated with an event, the event being associated with the ticket; and
a refund processor configurable to return the calculated current value of the ticket to the user.

21. The system according to claim 20, further comprising a return processor configurable to electronically return the ticket to the pool of available tickets.

22. The system according to claim 21, further comprising a transmitter configurable to transmit the information associated with the ticket.

23. The system according to claim 22, further comprising a receiver configurable to receive the information associated with the event.

24. The system according to claim 23, wherein the transmitter, the receiver, and the interface are each implemented in a kiosk.

25. The system according to claim 20, wherein the interface comprises a ticket scanner.

26. The system according to claim 20, wherein the current value processor is implemented by one of the ticket issuer, a third party and an owner of the interface.

27. The system according to claim 20, wherein the refund processor is implemented by one of the ticket issuer, a third party and an owner of the interface.

28. The system according to claim 21, wherein the return processor is implemented by one of the ticket issuer, a third party and an owner of the interface.

29. The system according to claim 24, wherein at least one of the current value processor, the refund processor and the return processor are implemented on the kiosk.

30. The system according to claim 20, further comprising an invalidating processor configurable to invalidate the ticket.

31. The system according to claim 30, wherein invalidating the ticket comprises capturing the ticket, destroying the ticket, marking the ticket in a manner visible to the user and marking the ticket in a manner not visible to the user.

32. The system according to claim 31, wherein marking the ticket in the manner not visible to the user comprises deactivating a magnetic strip on the ticket.

33. The system according to claim 20, wherein the information associated with the event is obtained via at least one of: the ticket issuer, a coordinator of the event, an owner of a venue associated with the event, a third party and the Internet.

34. They system according to claim 20, wherein the information associated with the event is obtained in real-time over a communications link.

35. The system according to claim 20, wherein the information associated with the event is received at periodic time intervals over a communications link.

36. A tangible computer readable medium executable to store computer program that refunds a current value of a ticket to a user, the ticket having previously been purchased from a ticket issuer out of a pool of tickets, the medium comprising an receiving code executable to obtain information associated with the ticket;
a calculating code executable to determine the current value of the ticket based on at least one of the information associated with the ticket and information associated with an event, the event being associated with the ticket; and
a refund code executable to refund the determined current value of the ticket to the user.

37. The tangible computer readable medium according to claim 36, further comprising a return code executable to return the ticket to the pool of available tickets.

38. A method of refunding a current value of an event ticket to a user, the event ticket having previously been purchased from a ticket issuer out of a pool of available tickets, the method comprising:
obtaining information associated with the event ticket;
determining the current value of the event ticket based on at least one of the information associated with the event ticket, based on ticket holder information and information associated with an event, the event being associated with the event ticket;
refunding the determined current value of the event ticket to the user; and
returning the event ticket to the pool of available tickets, the pool of available tickets being associated with the ticket issuer.
